(19) United States
(12) Patent Application Publication
(10) Pub. No.: US 2015/0226166 A1
(43) Pub. Date: Aug. 13, 2015

(54) DEVICE FOR REDUCING PULSATION

(71) Applicant: Hyundai Motor Company, Seoul (KR)

(72) Inventor: Jin Chul HONG, Seoul (KR)

(73) Assignee: Hyundai Motor Company, Seoul (KR)

(21) Appl. No.: 14/459,998

(22) Filed: Aug. 14, 2014

(30) Foreign Application Priority Data
Feb. 11, 2014 (KR) 10-2014-0015608

(51) Int. Cl. F02M 55/02; F02M 69/46

(52) U.S. Cl. CPC F02M 55/025; F02M 69/465; F02M 2200/306

(57) ABSTRACT

A device for reducing pulsation may include a fuel rail configured to be supplied with fuel and provided with a fuel hole, an injector cup configured to be connected to an injector injecting the fuel and disposed at a fuel hole side of the fuel rail, and a damper disposed between the fuel rail and the injector cup to reduce the pulsation.

### CROSS-REFERENCE TO RELATED APPLICATION

The present application claims priority of Korean Patent Application Number 10-2014-0015608 filed on Feb. 11, 2014, the entire contents of which application is incorporated herein for all purposes by this reference.

### BACKGROUND OF INVENTION

1. Field of Invention

The present invention relates to a device for reducing pulsation, and more particularly, to a device for reducing pulsation capable of reducing pulsation which occurs between an injector cup and a fuel rail when fuel is injected into an injector.

2. Description of Related Art

Generally, a fuel apparatus of a vehicle is a system which continuously injects an appropriate amount of fuel into a combustion chamber of an engine depending on a driving control degree of the engine and injects fuel, which is sucked and pumped by a fuel pump, into a plurality of injectors equipped in the combustion chamber of the engine along a pipe conduit from a fuel tank and enables the plurality of injectors to inject the fuel.

Further, a precipitator and a fuel filter are equipped on the pipe conduit between the fuel tank and the fuel pump to precipitate and filter foreign materials, and the like and a delivery pipe connected to another pipe conduit to the fuel pump is coupled with the plurality of injectors.

However, according to the related art, the injector is operated and then some of the fuel in the injector cup moves into the delivery pipe via a fuel passage part. In this case, the existing structure has a problem in that the fuel is injected and then the fuel pulsation occurring within the injector cup is directly delivered to the delivery pipe to cause vibrations and fuel injection noise.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made to solve the above-mentioned problems occurring in the prior art and/or other problems while advantages achieved by the prior art are maintained intact. The present invention is directed to provide a device for reducing pulsation capable of reducing pulsation which occurs between an injector cup and a fuel rail when fuel is injected into an injector.

In various aspects of the present invention, there is provided a device for reducing pulsation including: a fuel rail configured to be supplied with fuel and provided with a fuel hole; an injector cup configured to be connected to an injector injecting the fuel and disposed at a fuel hole side of the fuel rail; and a damper disposed between the fuel rail and the injector cup to reduce the pulsation.

In one aspect, an inside of the damper may be provided with a plate formed with a through hole through which the fuel moves. In another aspect, an inside of the damper may be provided with a plurality of plates, each formed with at least one through hole through which the fuel moves, wherein a through hole formed on any one of the plurality of plates is positioned to intersect fluidically a through hole formed on an adjacent plate in the plurality of plates.

The device for reducing pulsation may further include an elastic body disposed between the plate and an inner side of the damper.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating an exemplary device for reducing pulsation according to the present invention;

FIG. 2(a) is a cross-sectional view illustrating an exemplary device for reducing pulsation according to the present invention;

FIG. 2(b) is a view illustrating an exemplary plate in an exemplary device for reducing pulsation according to the present invention;

FIG. 3(a) is a cross-sectional view illustrating another exemplary device for reducing pulsation according to the present invention; and

FIG. 3(b) is a view illustrating an exemplary plate in an exemplary device for reducing pulsation according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

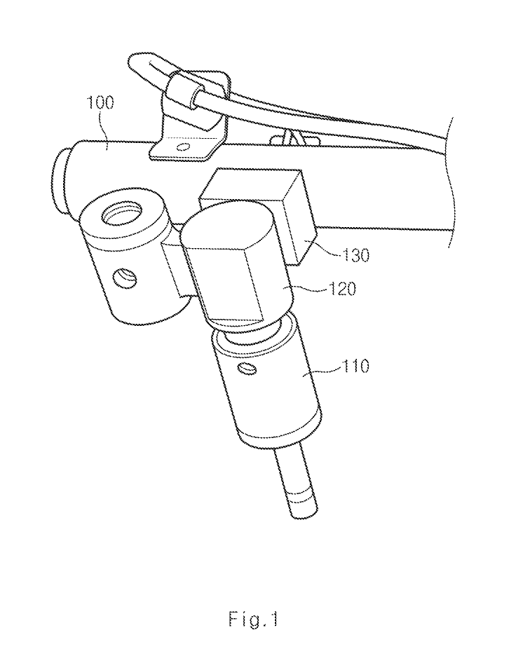

As illustrated in FIGS. 1 to 3, a device for reducing pulsation according to various embodiments of the present invention includes a fuel rail 100 to which fuel is supplied, an injector cup 120 which is disposed between injectors 110 and a fuel rail 100 and connects the injectors 110 and a fuel rail 100, and a damper 130 which is disposed between fuel rail 100 and the injector cup 120 and connects fuel rail 100 and the injector cup 120.

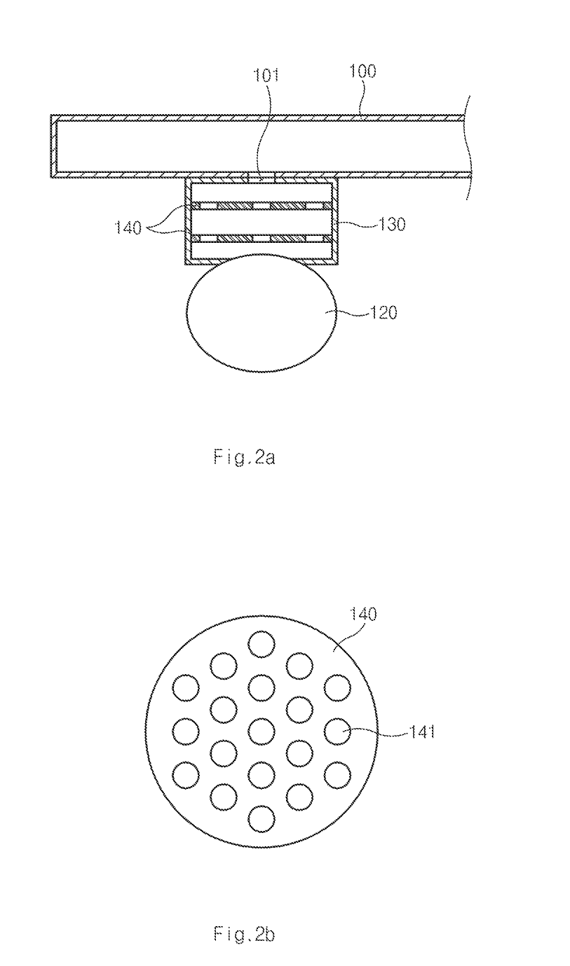

As illustrated in FIGS. 1 and 2, when fuel stored in a fuel tank is pumped by a fuel pump according to an operation of an engine and thus is supplied to a pipe-shaped fuel rail 100, a pressure controller equipped at one side of the fuel rail 100 may constantly keep a pressure of fuel at all times.

In this case, the fuel rail 100 controls an electrical pulse time to the injectors 110 based on an output signal input to an electronic control unit (ECU) depending on a load condition of the engine to allow each of the fuel injectors 110 to sequentially inject fuel, thereby appropriately carrying out fuel injection depending on the load condition of the engine.

The injector cup 120 is connected to the injector 110 which injects fuel and is equipped at a fuel hole 101 formed on the fuel rail 100 to be introduced with fuel supplied from the fuel rail 100 through the fuel hole 101 and deliver the fuel to the injector 110, such that the injector 110 may carry out the fuel injection.

The damper 130 is equipped between the fuel rail 100 and the injector cup 120. Meanwhile, the damper 130 has a cylindrical shape, and when the fuel supplied through the fuel hole 101 of the fuel rail 100 is delivered to the injector cup 120, a volume of the damper 130 is secured at a predetermined level or more to cause fluid damping, thereby primarily reducing pulsation. Further, the damper 130 may have a larger diameter than that of the fuel hole 101 so that the pressure of fuel introduced from the fuel hole 101 is reduced to cause the pulsation is caused.

In some embodiments, an inside of the damper 130 may be preferably provided with plates 140 which are provided with a plurality of through holes 141 through which the fuel may move. In this configuration, the plurality of plates 140 are disposed in the damper 130 and thus mounted in the damper 130 at a predetermined interval and the through hole 141 which is disposed in any one of the plates 140 is machined to intersect fluidically the through hole 141 disposed on the plate 140 facing the same, such that each of the through holes 141 may be disposed so as not to penetrate through the same position.

In this case, the plate 140 partitions the damper 130 into a plurality of spaces and the through hole 141 serves as an orifice so that a difference in pressure is present in the plurality of spaces of the damper 130.

Further, the plurality of spaces of the damper 130 are sequentially formed from the fuel rail 100 toward the injector cup 120 so that as the fuel flows from the fuel rail 100 toward the injector cup 120, the pressure is reduced to reduce the pulsation.

As the result, after the injector 110 performs the injection operation, a space is secured by the damper 130 which is equipped between the injector cup 120 and the fuel rail 100 to serve as an orifice to primarily reduce pulsation and then reduce a change in pressure occurring while fuel passes through the through hole 141 disposed on the plate 140 of the damper 130, thereby reducing the pulsation and solving the occurrence problem of noise due to the pulsation.

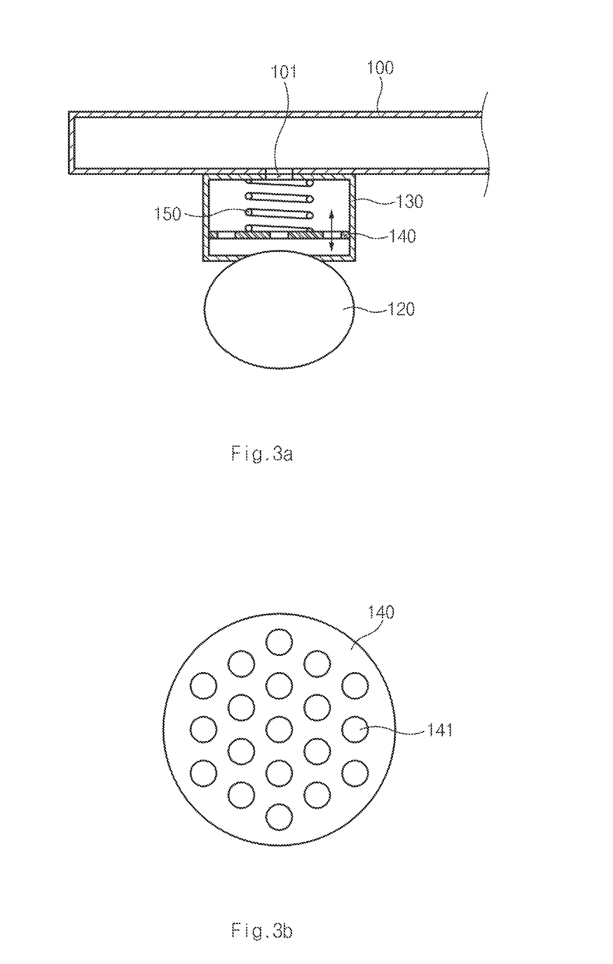

Further, according to another embodiment of the present invention, as illustrated in FIG. 3, an elastic body 150 may be provided between the plate 140 and an inner side of the damper 130 in the state in which the plate 140 on which the plurality of through holes 141 are disposed is provided to move fuel in the damper 130 and thus the elastic body 150 absorbs pulsation energy of fuel by moving the plate 140 depending on tension and compression of the elastic body 150, thereby preferably reducing the pulsation.

That is, according to various embodiments of the present invention, after the injector performs the injection operation, the space is secured by the damper 130 which is equipped between the injector cup 120 and the fuel rail 100 to primarily reduce the pulsation and then the plate 140 on which the through hole 141 is disposed is inserted into the inside of the damper 130 to reduce the pulsation. In this state, the elastic body 150 is disposed between the fuel hole 101 of the fuel rail 100 and the plate 140 and is tensioned and compressed depending on the movement of fuel to move the plate 140 so that the pulsation energy by the fuel is converted into elastic energy, thereby implementing the reduction in pulsation.

As set forth above, according to various embodiments of the present invention, it is possible to improve the noise of the injector by reducing the occurrence of fuel pulsation, thereby improving marketability.

For convenience in explanation and accurate definition in the appended claims, the terms “inner”, “inside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents. made without departing from the scope defined in the following claims.

What is claimed is:

1. A device for reducing pulsation, comprising:
a fuel rail configured to be supplied with fuel and provided with a fuel hole;
an injector cup configured to be connected to an injector injecting the fuel and disposed at a fuel hole side of the fuel rail; and
a damper disposed between the fuel rail and the injector cup to reduce the pulsation.

2. The device according to claim 1, wherein an inside of the damper is provided with a plate formed with a through hole through which the fuel moves.

3. The device according to claim 1, wherein an inside of the damper is provided with a plurality of plates, each formed with at least one through hole through which the fuel moves, wherein a through hole formed on any one of the plurality of plates is positioned to intersect fluidically a through hole formed on an adjacent plate in the plurality of plates.

4. The device according to claim 2, further comprising:
an elastic body disposed between the plate and an inner side of the damper.

5. The device according to claim 1, wherein the damper has a larger diameter than that of the fuel hole so that a pressure of fuel introduced from the fuel hole is reduced to reduce the pulsation.

6. The device according to claim 2, wherein the plate partitions the damper into a plurality of spaces and the through hole serves as an orifice so that a difference in pressure is present in the plurality of spaces of the damper.

7. The device according to claim 6, wherein the plurality of spaces of the damper are sequentially formed from the fuel rail toward the injector cup so that as the fuel flows from the fuel rail toward the injector cup, the pressure is reduced to reduce the pulsation.
